(19) United States
(12) Patent Application Publication
(10) Pub. No.: US 2025/0091368 A1
(43) Pub. Date: Mar. 20, 2025

(54) DIGITAL PRINTING MACHINE AND PRINTING METHOD

(71) Applicant: Angelo SCHIESTL, Langkampfen (AT)

(72) Inventor: Angelo SCHIESTL, Langkampfen (AT)

(21) Appl. No.: 18/580,383

(22) PCT Filed: Nov. 24, 2022
(86) PCT No.: PCT/EP2022/083101

§ 371 Date: Jan. 18, 2024

(30) Foreign Application Priority Data
Dec. 7, 2021 (EP) 21212887.0

(51) Int. Cl. B41J 11/14; B41J 3/407; B41J 11/00; B41J 11/06; B41J 25/308; D06P 5/30

(52) U.S. Cl. CPC B41J 11/14; B41J 3/4078; B41J 11/0095; B41J 11/06; B41J 25/308; D06P 5/30

(57) ABSTRACT

The invention relates to a digital printing machine, in particular for printing textiles, with a frame, at least one receiving carriage for receiving and holding a printing product, in particular a textile, wherein the receiving carriage is displaceable in a horizontal in a longitudinal direction along the frame, and at least one printing carriage with a print head having one or several ink jet nozzles, wherein the printing carriage is displaceable on the frame in a transverse direction. According to the invention provision is made in that the receiving carriage has a base carriage and a receiving table which is adjustable relative to the base carriage in a vertical direction which is perpendicular to the horizontal, and in that a drive is provided for vertical adjustment of the receiving table with respect to the base carriage.

The invention relates to a digital printing machine, in particular for printing textiles, with a frame, at least one receiving carriage for receiving and holding a printing product, in particular a textile, wherein the receiving carriage is displaceable in a horizontal in a longitudinal direction along the frame, and at least one printing carriage with a print head having one or several ink jet nozzles, wherein the printing carriage is displaceable on the frame in a transverse direction, in accordance with the preamble of claim 1.

The invention further relates to a printing method for printing a printing product with a digital printing machine which has a frame, at least one receiving carriage for receiving and holding a printing product, in particular a textile, wherein the receiving carriage is displaced in a horizontal in a longitudinal direction of the frame, and at least one printing carriage with a print head having one or several ink jet nozzles, wherein during printing the printing carriage is displaced on the frame in a transverse direction, in accordance with the preamble of claim 9.

A generic textile printing machine can be taken from EP 3 184 313 A1 for example. On a frame two receiving carriages are arranged so as to be displaceable parallel to each other in a longitudinal direction. The receiving carriages are designed to receive and hold a textile, such as a T-shirt or a sweatshirt. Above the receiving carriages two printing carriages are supported on a transverse beam in a direction transverse to the longitudinal direction. Each printing carriage has a plurality of ink jet nozzles, with which a desired print image is applied onto the respective textile. For this purpose, the receiving carriages with the textile are displaced in the longitudinal direction underneath the printing carriage, with the print image being applied line-by-line by displacing the printing carriages and the receiving carriages in a coordinated way to each other.

For the quality of the print image a defined distance between the printing nozzles and the printing surface on the textile is of vital importance. If the distance is too small too much printing ink can be applied per surface onto the textile, whereby a elapsing (bleeding) of colors may occur. Moreover, this may entail an excessive consumption of printing ink.

If the distance between printing nozzle and textile is too large the sharpness of contours will be lost and the applied print image can appear blurred and indistinct.

It is known that a printing machine is set up for printing a specific textile. Usually, as many printing products of the same type as possible are then printed in this set-up. If a change of the printing product then takes place, for instance from a relatively thin T-shirt to a thicker sweatshirt or a pullover, the set-up on the machine has to be changed manually, with components being partially converted or exchanged. This is time-consuming and work-intensive. It is therefore common practice to print as many printing products of the same type as possible in one setting so that the laborious conversion measures do not have to be undertaken too frequently.

The invention is based on the object to provide a printing machine and a printing method, with which printing products of different wall thicknesses can be printed in a particularly efficient way.

The object is achieved on the one hand by a digital printing machine having the features of claim 1 and on the other hand by a printing method having the features of claim 9. Preferred embodiments are stated in the dependent claims.

The printing machine according to the invention is characterized in that the receiving carriage has a base carriage and a receiving table which is adjustable relative to the base carriage in a vertical direction that is perpendicular to the horizontal, and in that vertical adjustment of the receiving table with respect to the base carriage is carried out by means of a drive.

A basic idea of the invention resides in the fact that the receiving table is arranged in an adjustable manner on a base carriage of the receiving carriage. Through height adjustability of the receiving table a compensation of possible changes in thickness of the printing product to be printed, in particular a textile, can be achieved in an efficient way.

According to a further aspect of the invention this is in particular facilitated in that height adjustment takes place by means of a drive. By way of a motor the drive brings about a change of position of the receiving table with respect to the base carriage. This takes place rapidly and without any effort required for a machine operator.

As a result, height adjustment of the receiving table can take place without any problem during loading or unloading of a printing product on or from the receiving table so that printing products of different material thicknesses can be processed and printed with virtually no loss of time. This increases the flexibility during operation of the printing machine while at the same time ensuring that a distance as optimal as possible between the printing nozzles and the printing product is set at all times.

Basically, for adjustment a manual actuation or control means can be provided for a machine operator. According to a further development of the invention an especially efficient printing operation is achieved in that a control means is provided which is designed for automatic adjustment of the receiving table in the vertical direction.

Basically, on the control means, which is conventionally designed with buttons or with a display with indicated operating panels, a choice of possible printing products, in particular textiles, can be displayed to a machine operator for preselection. On corresponding selection by the machine operators the control means then implements a defined and previously stored height setting of the receiving table with respect to the base carriage. In doing so, the drive is activated directly by the control means.

According to an embodiment of the invention it is preferred that at least one sensor means is provided, by which a thickness of the printing product, in particular a textile, can be determined that is held on the receiving table, and in that the sensor means is connected to the control means, wherein a vertical adjustment of the receiving table takes place depending on the thickness of the printing product received. The sensor means can directly detect a thickness. Alternatively, the sensor means can also detect the type of printing product, in particular the textile, wherein by way of data stored in a storage a corresponding thickness is in each case assigned to a specific printing product. Hence, according to the data stored with regard to thickness or material strength the control means can activate the drive and implement a necessary height adjustment.

In principle, adjustment of the receiving table with respect to the base carriage can take place directly by way of adjusting elements, such as vertically directed positioning cylinders. A preferred further development of the invention resides in the fact that between the base carriage and the receiving table an adjustment mechanism is provided, with which a vertical adjustment takes place. The adjustment mechanism can have mechanical elements such as levers and/or gear wheels which enable a particularly precise and reliable setting.

According to a further development of the invention it is especially advantageous that the adjustment mechanism can have a scissor mechanism. A scissor mechanism consists of at least two levers that are linked with respect to each other and can be pivoted in a scissor-type manner towards or away from each other. In particular, the scissor mechanism can also have more than two levers that are arranged in parallel and/or one behind the other. Through a corresponding translation or reduction a change of the positioning force and also of the positioning distance can be achieved with respect to a positioning drive. Particularly in the latter case a very fine and precise adjustment can take place in the vertical direction.

Furthermore, according to an embodiment variant of the invention it is particularly expedient that the drive is designed as a linear drive which is arranged on the receiving carriage in the longitudinal direction or the transverse direction. This allows an especially compact arrangement.

It is particularly advantageous for the drive to be designed as a positioning cylinder or a spindle drive. The positioning cylinder can be driven pneumatically or, by preference, hydraulically. By way of a spindle drive a threaded spindle driven by the drive can be in meshing connection with a corresponding threaded bore or threaded sleeve of a linear drive element so that this is moved linearly.

A further increase in flexibility can be achieved in the printing machine according to the invention in that the receiving table has an adapter element, on which a plate-shaped receiving element is attached in a releasable and easily changeable manner. The adapter element can have a base table, on which different plate-shaped receiving elements are attached in a changeable manner. The different plate-shaped receiving elements can be adapted to a respective printing product, in particular a textile. On the receiving element provision can also be made for a holding means, more particularly a movable holding frame for holding or fixing in particular a textile on the receiving element. As a result, particularly good adaptation of the receiving table and thus of the printing machine to different printing products can be realized not only in height but also in width and length.

According to a further development of the invention a further improvement with regard to flexibility is achieved in that a detection means is arranged, by which the plate-shaped receiving element attached on the adapter element can be detected. On the receiving element provision can be made e. g. for an RFID-chip or another identification which can be detected and/or queried by the detection means in order to thereby recognize the exact type of the receiving element applied. Depending on the receiving element thus detected it is then possible for the control means to automatically set and adapt further operating parameters of the printing machine.

An especially advantageous embodiment of the invention resides in the fact that by the control means a displacement range of the printing carriage and/or the ink jet nozzles can be set depending on detected values. For example, if a plate-shaped receiving element for a small textile element is applied, the displacement distance of the printing carriage in the transverse direction can be reduced correspondingly.

If, on the other hand, a receiving element for a larger textile size is applied the displacement distance of the printing carriage can be enlarged accordingly. Through a corresponding shift of the reversal points of the printing carriage unnecessary idle travels during line-by-line back- and forth-movement of the ink jet nozzles can be reduced. The same applies accordingly to the setting and adaptation of the displacement distance of the receiving carriage in the longitudinal direction. This increases the efficiency of the machine and reduces required printing times.

According to a further development of the invention another improvement can be achieved in that the print head with the ink jet nozzles is supported on the printing carriage by being adjustable in the vertical direction. Thus, for height setting not only an adjustment of the receiving table can be provided but also an adjustment of the ink jet nozzles with respect to the printing carriage. In this way, a relatively large adjustment range exists in the vertical direction, which further increases the flexibility of the printing machine with regard to printing different printing products.

The invention further comprises a printing method for printing a printing product which is characterized in that the receiving carriage has a base carriage and a receiving table which, prior to printing, is adjusted relative to the base carriage in a vertical direction which is perpendicular to the horizontal, and in that vertical adjustment of the receiving table with respect to the base carriage is carried out by means of a drive.

The printing method according to the invention can in particular be carried out by the previously described printing machine according to the invention in the different embodiment variants described beforehand. The advantages described in each case can be achieved thereby.

The invention is explained further hereinafter by way of a preferred embodiment example illustrated schematically in the drawings, wherein show:

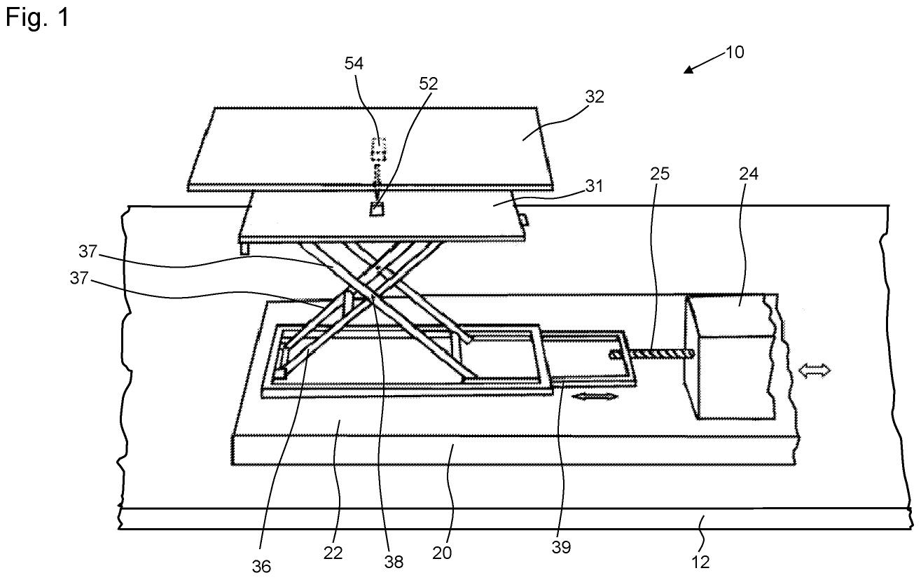

FIG. 1 a perspective partial view of a printing machine according to the invention prior to printing; and

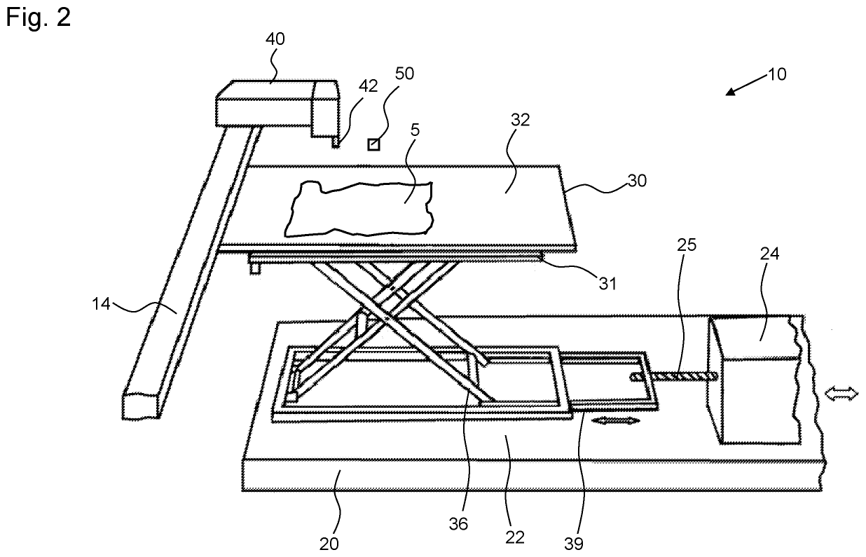

FIG. 2 a perspective view of the printing machine of FIG. 1 during printing.

A printing machine 10 pursuant to the invention and according to FIGS. 1 and 2 has a frame 12 which is indicated only schematically and on which a receiving carriage 20 is supported horizontally and displaceable in a longitudinal direction. Furthermore, on the frame 12, running in a transverse direction, i.e. substantially perpendicularly to the longitudinal direction, a guide beam 14 is arranged above the receiving table 20. Along the guide beam 14 a printing carriage 40 with a print head 42 and a plurality of ink jet nozzles 44 is supported by being displaceable in the transverse direction.

The receiving carriage 20 has a base carriage 22 and a receiving table 30 that is supported thereon by being adjustable in height. Between the base carriage 22 and the receiving table 30 an adjustment mechanism 36 for height adjustment of the receiving table 30 is arranged.

The adjustment mechanism 36 has a scissor mechanism formed by levers 37, the levers 37 intersecting each other in a scissor-like manner and being pivotably connected to each other via a central joint 38. A part of the levers 37 is linked to a movable slide 39 which is slidably supported on the preferably planar or plate-shaped base carriage 22.

For height adjustment of the receiving table 30 a drive 24 with a rotatably drivable threaded spindle 25 is arranged on the receiving carriage 20. The threaded spindle 25 meshes with a non-depicted threaded part on the slide 39 in order to transform a rotating movement of the threaded spindle 25 into a longitudinal movement of the slide 39 to adjust the adjustment mechanism 36. Through the scissor mechanism the longitudinal movement is translated into a vertical movement.

In the illustrated embodiment the receiving table 30 has an adapter element 31 which is connected or coupled to the adjustment mechanism 36. On the adapter element 31 a plate-shaped receiving element 32 can be attached in a releasable and easily changeable manner. The plate-shaped receiving element 32 can thus be adapted to the size of a printing product 5 to be printed.

On the adapter element 31 a detection means 52 for detecting the type and/or size of the receiving element 32 to be applied or applied can be arranged. For this purpose, a marking 54, in particular an RFID-chip, can be attached on the plate-shaped receiving element 32.

By way of a sensor means 50 which is indicated only schematically and can preferably be arranged on the frame 12 or the printing carriage 40, the printing product 5 and/or a thickness of the printing product 5 on the receiving table 30 can be detected. Depending on the thickness detected it is possible by way of a non-depicted control means that the adjustment mechanism 36 can be adjusted automatically by means of the drive 24 such that a distance between the printing product 5 and the ink jet nozzles 42 is set which distance is suitable for the printing process. As a result, the printing machine 10 can print different printing products 5 of different material thicknesses, with the suitable distance being set automatically between the printing nozzles 42 and the printing product 5.

1-9. (canceled)

10. A digital textile printing machine for printing textiles, with
a frame,
at least one receiving carriage for receiving and holding a printing product, in the form of a textile, wherein the receiving carriage is displaceable in a horizontal in a longitudinal direction along the frame, and
at least one printing carriage with a print head having one or several ink jet nozzles, wherein the printing carriage is displaceable on the frame in a transverse direction,
wherein the receiving carriage has a base carriage and a receiving table which is adjustable relative to the base carriage in a vertical direction which is perpendicular to the horizontal,
wherein a drive is provided for vertical adjustment of the receiving table with respect to the base carriage,
wherein the receiving table has an adapter element, on which a plate-shaped receiving element is attached in a releasable and easily changeable manner,
wherein a detection means is arranged, by which the plate-shaped receiving element attached on the adapter element can be detected,
wherein by a control means a displacement range of the printing carriage and/or the ink jet nozzles can be set depending on detected values on the type of the applied receiving element,
wherein
the control means is designed for automatic adjustment of the receiving table in the vertical direction,
at least one sensor means is provided, by which a thickness of the printing product, in particular a textile, can be determined which is held on the receiving table, and
the sensor means is connected to the control means, wherein a vertical adjustment of the receiving table takes place depending on the thickness of the printing product received.

11. The digital textile printing machine according to claim 10,
wherein
between the base carriage and the receiving table an adjustment mechanism is provided, with which a vertical adjustment takes place.

12. The digital textile printing machine according to claim 11,
wherein
the adjustment mechanism has a scissor mechanism.

13. The digital textile printing machine according to claim 10,
wherein
the drive is designed as a linear drive which is arranged on the receiving carriage in the longitudinal direction or the transverse direction.

14. The digital textile printing machine according to claim 10,
wherein
the drive is designed as a positioning cylinder or a spindle drive.

15. The digital textile printing machine according to claim 10,
wherein
the print head with the ink jet nozzles is supported on the printing carriage by being adjustable in the vertical direction.

16. A printing method for printing a printing product, in the form of textiles, with a digital textile printing machine according to claim 10, which has
a frame,
at least one receiving carriage for receiving and holding a printing product, in particular a textile, wherein the receiving carriage is displaced in a horizontal in a longitudinal direction along the frame, and
at least one printing carriage with a print head having one or several ink jet nozzles, wherein during printing the printing carriage is displaced on the frame in a transverse direction,
wherein
the receiving carriage has a base carriage and a receiving table which, prior to printing, is adjusted relative to the base carriage in a vertical direction which is perpendicular to the horizontal, and
vertical adjustment of the receiving table with respect to the base carriage is carried out by means of a drive.
